(19) United States
(12) Patent Application Publication
(10) Pub. No.: US 2007/0079240 A1
(43) Pub. Date: Apr. 5, 2007

(54) METHOD FOR INTEGRATING USER INTERFACES OF MULTIMEDIA FILES

(76) Inventor: Jie Zhang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,209

(22) Filed: Mar. 13, 2006

(30) Foreign Application Priority Data
Oct. 4, 2005 (TW) 94134626

(51) Int. Cl. H04N 5/44

(52) U.S. Cl. 715/716

(57) ABSTRACT

A method for integrating user interfaces of multimedia files is disclosed. Because the method supports multimedia files, such as audio, video, and picture files simultaneously, only one media player program is needed to play and edit media files. In addition, different user interfaces are designed corresponding to different media files. In addition, a switch key is provided to switch to the user interface corresponding to the media file in operation. Therefore, the purpose of playing and editing different media files simultaneously is achieved.

### CROSS-REFERENCE TO RELATED APPLICATION

This application claims the priority benefit of Taiwan application serial no. 94134626, filed on Oct. 4, 2005. All disclosure of the Taiwan application is incorporated herein by reference.

### BACKGROUND OF THE INVENTION

1. Field of Invention

The present invention relates to a method for playing multimedia files, and more particularly, the present invention relates to a multimedia playing method for playing and editing multiple multimedia files simultaneously by using a switch key to switch among multiple multimedia user interfaces.

2. Description of Related Art

Along with the advancement of information technology, hi-tech products, such as broadband network, digital camera, and digital video etc., are widely used, and said network and digital electronic products can download digital files into PCs by connecting to the computers. Accordingly, a great number of multimedia files, such as picture, audio, and video files etc., are stored in the users' PCs. However, the most popular media player programs in market, e.g. Windows Media Player and Real Player etc, mainly support audio and video playing, the user has to open a picture viewing software, e.g. ACDSee, if he/she wants to browse and edit picture files, rather than playing audio or video files and browsing pictures simultaneously in the same application software.

In addition, in a typical media player program, the same kind of user interface is used for different types of media files. However, in actual application, the operational functions used by different types of media files are different. In other words, when playing music files, the user may need to lower the volume. On the other hand, when playing video files, the user may need to adjust the brightness of the screen.

Moreover, in a single media player program, the user can only perform the playing operation on one file, rather than playing and editing different media files simultaneously. In other words, when the user is playing music, he/she cannot rotate, change the size of, or automatically play a picture, which is very inconvenient.

### SUMMARY OF THE INVENTION

Accordingly, the present invention is directed to provide a method for integrating the user interfaces of multimedia files, which designs different user interfaces corresponding to different media files, and a switch key is used to switch among these user interfaces so as to achieve the purpose of supporting different types of media files with only one media player program.

According to another aspect of the present invention, a method for integrating the user interfaces of multimedia files, which can switch among the user interfaces of different types of media file by disposing a switch key in the user interfaces, to achieve the purpose of operating different types of media files, is provided.

The present invention provides a method for integrating the user interfaces of multimedia files, which includes the following steps: 1). reading and playing the first type of media file to display a first user interface corresponding to the first type of media file; 2). reading and playing the second type of media file to display a second user interface corresponding to the second type of media file and finally switching between the first user interface and the second user interface by clicking on an interface switch key.

The method for integrating the user interfaces of multimedia files in an exemplary embodiment of the present invention further includes clicking on a function key on the first user interface to perform an operation function on the first type of media file.

According to the method for integrating the user interfaces of multimedia files in an exemplary embodiment of the present invention, the aforementioned operation function includes one of a play function and an edit function.

According to the method for integrating the user interfaces of multimedia files in an exemplary embodiment of the present invention, the aforementioned play function includes one of play, pause, stop, fast forward/rewind, automatic display, volume adjustment, setting a play order, and window's size adjustment.

According to the method for integrating the user interfaces of multimedia files in an exemplary embodiment of the present invention, the aforementioned play order includes one of random play, sequence play, and loop play.

According to the method for integrating the user interfaces of multimedia files in an exemplary embodiment of the present invention, the aforementioned edit function includes one of zooming, rotating, editing, resizing, and image processing.

According to the method for integrating the user interfaces of multimedia files in an exemplary embodiment of the present invention, the aforementioned first type of media file and second type of media file include one of a picture file, an audio file, and a video file.

According to the method for integrating the user interfaces of multimedia files in an exemplary embodiment of the present invention, when the first type of media file is being played, the first user interface displays related information of the first type of media file. In addition, when the second type of media file is being played, the second user interface displays related information of the second type of media file.

The present invention provides a method for integrating the user interfaces of multimedia files, which includes the following steps: 1). reading and playing the first type of media file, and displaying a first user interface corresponding to the first type media file; 2). clicking an interface switch key on the first user interface to switch to the second user interface, wherein the second user interface corresponds to the second type of media file; and finally reading and playing the second type of media file through the second user interface.

In the present invention, since different user interfaces are designed corresponding to different media files, only one media player program is needed to operate all types of media files, and a switch key is provided to switch to the user interface corresponding to the media file desired to operate. Therefore, the purpose of playing and editing different types of media files simultaneously is achieved.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating the method for integrating the user interfaces of multimedia files according to an exemplary embodiment of the present invention.

FIG. 2 is a diagram illustrating the user interface of an audio file according to an exemplary embodiment of the present invention.

FIG. 3 is a diagram illustrating the user interface of a video file according to an exemplary embodiment of the present invention.

FIG. 4 is a diagram illustrating the user interface of a picture file according to an exemplary embodiment of the present invention.

FIG. 5 is a flowchart illustrating the method for integrating the user interfaces of multimedia files according to another exemplary embodiment of the present invention.

### DESCRIPTION OF EMBODIMENTS

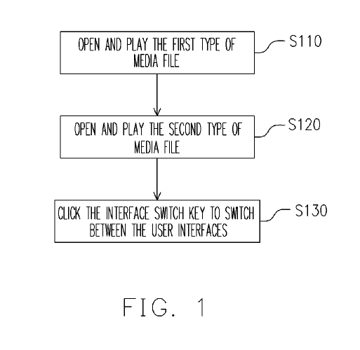

FIG. 1 is a flowchart illustrating the method for the user interfaces integrating multimedia files according to an exemplary embodiment of the present invention. Referring to FIG. 1, in the present embodiment, two different types of media files are read first, and then played and edited at the same time, respectively, by a switch key changing the interfaces corresponding to the two media files when editing and playing the two different media files.

First, the user selects a media file in the browse dialog, such as window's file manager or the equivalent, on the computer screen, and reads the media file by double-clicking the left button of the mouse, and then the media player program of the present invention is launched to open and plays the media file. In the meantime, an user interface corresponding to this type of media file is displayed on the screen (step S110) in which the type of the aforementioned media file is not limited to, but it can be any type of multimedia file, such as a picture file, an audio file, or a video file, etc.

In the next step, the user can read another type of media file in the same way, and then the media player program is launched to play the media file, and an user interface corresponding to this type of media file is displayed on the screen (step S120) at the same time. The user can further open more different types of media files simultaneously, and the user interface of the media player program in display remains the interface corresponding to the type of the most lately opened media file.

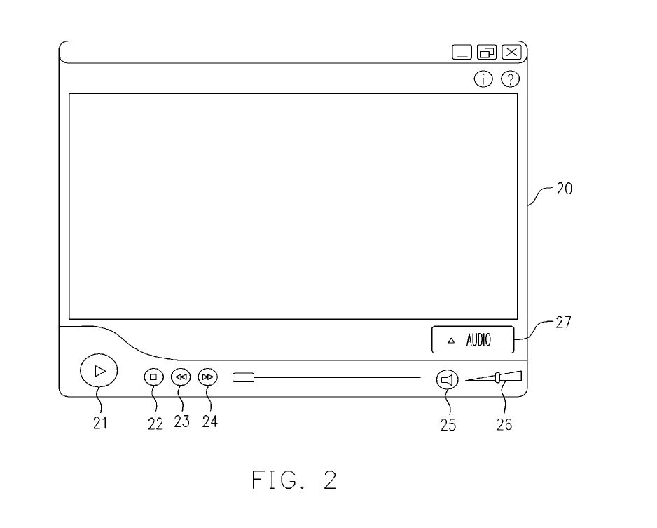

The user interface described above in display depends on the type of the media file opened by the user. If the user opens an audio file, the media player program shows the user interface for playing audios (as shown in FIG. 2). The related data and buttons of the audio file are shown in the window of the user interface, and the user interface may have a plurality of function keys to allow the user to perform a job on the audio file with the click of a function key. In the present embodiment, the function keys of the user interface handling audio files include play key 21, stop key 22, fast rewind key 23, fast forward key 24, sound key 25, volume adjustment key 26, and interface switch key 27, etc.

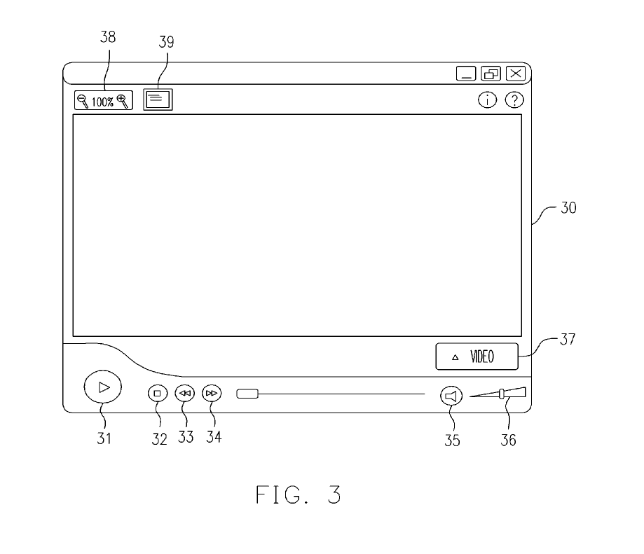

In an embodiment, the media player program displays the user interface for playing videos (as shown in FIG. 3) if the user opens a video file. The related data of the video file is shown in the window of the user interface, and the function keys of the user interface include play key 31, stop key 32, fast rewind key 33, fast forward key 34, sound key 35, volume adjustment key 36, interface switch key 37, resize key 38, and full screen key 39, etc.

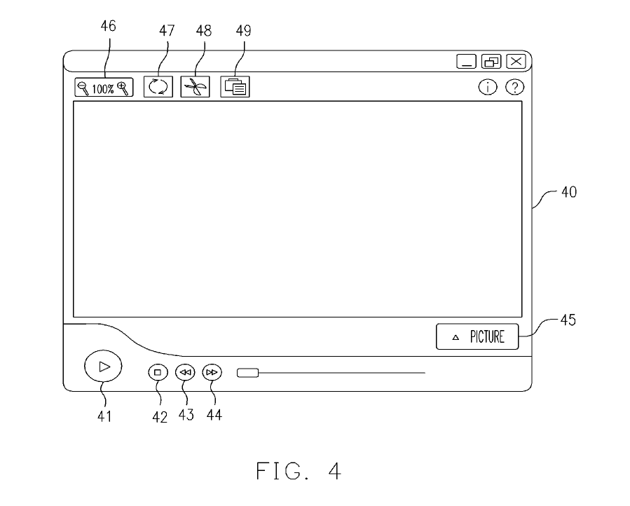

In another embodiment, the media player program shows the user interface for playing pictures (as shown in FIG. 4) if the user opens a picture file. Wherein, the related data of the picture file is shown in the window of the user interface, and the function keys of the user interface include play key 41, stop key 42, previous page key 43, next page key 44, interface switch key 45, resize key 46, rotate key 47, cut key 48, and paste key 49 etc.

The settings of function keys in the user interfaces described above are only some embodiments of the present invention. The operation functions thereof may include play functions, such as play, pause, stop, fast forward/rewind, automatic display, volume adjustment, window's size adjustment, random play, sequence play, and loop play etc., or edit functions, such as zooming, rotating, editing, resizing, and image processing etc. The range of operation functions is not limited to, and the user can add or delete some function keys as required without departing from the spirit of the present invention. In another embodiment, the interface switch keys 27, 37, and 45 in FIGS. 2, 3, and 4 can be integrated into one switch key. In other words, if the user plays a music file, he/she clicks the switch key 27 in FIG. 2, and the switch key 27 will pop out a menu. This menu is for selecting window, picture or video, to switch to.

In addition, the user can open the same type of media files repeatedly. The media player program stops playing the previous media file and starts to play the next media file when the program receives such a play command. Accordingly, the play order of the media player program in the present invention is determined based on the sequence of the media files the user opens.

When the user opens and plays more than one type of media files simultaneously, the interface switch key, the interface switch keys 27, 37, and 45 in FIGS. 2, 3, and 4 in the user interface, these interfaces can be used to switch from an to (step S130), allowing the user to execute functions, such as play, edit and so forth on the media file played by these function keys on the user interface.

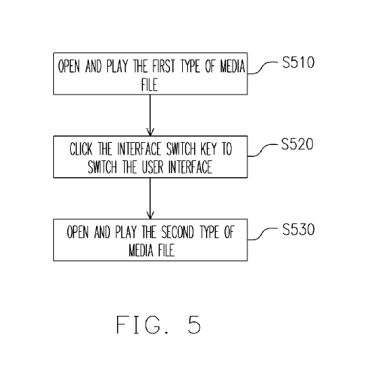

FIG. 5 is a flowchart illustrating the method for integrating the user interfaces of multimedia files according to another exemplary embodiment of the present invention. Referring to FIG. 5, in the present embodiment, a media file is opened and, then a switch key is used to switch to another user interface corresponding to another type of media file. In the meantime, another type of media file is played and edited through this user interface.

Similar to the embodiment described above, the user selects a media file on the computer's screen and opens the media file by double-clicking the left button of the mouse, and then the computer calls the media player program of the present invention to open and play the media file. In the meantime, a user interface corresponding to the type of the media file is shown on the screen (step S510).

In the next step, the user chooses to switch to the type of the media file to open through the interface switch key shown in the user interface. The user interface shown on the screen is changed to the user interface corresponding to the type of the selected media file (step S520).

Finally, a media file of another type is opened and played through the user interface (step S530) wherein the aforementioned type of media file may be a picture file, an audio file, or a video file, and the corresponding user interface may also include different function keys without limitation in the range thereof.

Based on the steps described above, another embodiment will be explained here. First, the user selects to open a music file, and then the computer calls the media player program to play the music file. In the meantime, the user interface corresponding to audio files as shown in FIG. 2 is shown on the computer's screen, and then the user can use the function keys on the user interface 20 to control the computer to play the music file.

If the user wants to edit a photo at the same time when the music is being played, the user can switch the user interface 20 to the user interface 40 corresponding to picture files (as shown in FIG. 4) by using the interface switch key 27 on the user interface 20. In addition, the user can open and edit the photo using the function keys on the user interface 40. With the above steps, the user can listen to the music and edit the photo on the computer simultaneously; therefore, the inconvenience of having to open different software programs is avoided.

In addition, in an embodiment, the present invention can be implemented as a play module of an application program or of a machine-readable medium. When the user selects a media file in the application program, he/she can trigger the application program to call the play module by clicking “play” button with the mouse to execute the play function provided by the present invention.

In another embodiment, the present invention can be further implemented as a remote player program, the user can call the remote player program to play a media file after he/she chooses to open the media file through the control program on an electronic product such as a local computer, a pocket PC, or a PDA, etc. The transmission of command or data between two computing devices is made possible via the Bluetooth or WiFi or 802.11 protocal.

In view of the foregoing, according to the method for integrating the user interfaces of multimedia files in the present invention, only one media player program is needed to play and edit media files because multimedia files such as audio, video, and picture files are supported simultaneously,. In addition, different user interfaces are designed corresponding to different media files and a switch key is provided to change the user interface corresponding to the media file desired to operate. Therefore, the purpose of playing and editing different media files simultaneously is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for integrating a plurality of user interfaces of multimedia files, comprising:
reading and playing a first type of media file from a computing device;
displaying a first user interface corresponding to the first type of media file;
clicking an interface switch key on the first user interface to switch to a second user interface, wherein the second user interface corresponds to a second type of media file; and
reading and playing the second type of media file through the second user interface.

2. The integrating method according to claim 1, the method further including:
clicking a first function key on the first user interface to execute a function on the first type of media file.

3. The integrating method according to claim 1, the method further including:
clicking a second function key on the second user interface to execute a function on the second type of media file.

4. The integrating method according to claim 1, wherein when the first type of media file is being played, the first user interface shows related information of the first type media file.

5. The integrating method according to claim 1, wherein when the second type of media file is being played, the second user interface shows related information of the second type of media file.

6. A machine readable medium having stored thereon executable program code which, when executed, causes a computing device to perform a method for altering a window displayed on a computer controlled display system, said method comprising: reading and playing a first type of media file from the computing device;
displaying a first user interface corresponding to the first type of media file on the window;
clicking an interface switch key on the first user interface to switch to a second user interface, wherein the second user interface corresponds to a second type of media file on the window; and
reading and playing the second type of media file through the second user interface on the window.

7. The machine readable medium according to claim 6, the method further including:
clicking a first function key on the first user interface to execute a function on the first type of media file.

8. The machine readable medium according to claim 6, the method further including:
clicking a second function key on the second user interface to execute a function on the second type of media file.

9. The machine readable medium according to claim 6, wherein when the first type of media file is being played, the first user interface shows related information of the first type media file.

10. The machine readable medium according to claim 6, wherein when the second type of media file is being played, the second user interface shows related information of the second type of media file.

11. A digital processing system for integrating a plurality of user interfaces displayed on a computer controlled display system, said digital processing system comprising:
means for reading and playing a first type of media file from the computer controlled display system;
means for displaying a first user interface corresponding to the first type of media file;
means for clicking an interface switch key on the first user interface to switch to a second user interface, wherein the second user interface corresponds to a second type of media file; and
means for reading and playing the second type of media file through the second user interface.

12. The digital processing system according to claim 11, wherein further including:
means for clicking a first function key on the first user interface to execute a function on the first type of media file.

13. The digital processing system according to claim 11, wherein further including:
means clicking a second function key on the second user interface to execute a function on the second type of media file.

14. The digital processing system according to claim 11, wherein when the first type of media file is being played, the first user interface shows related information of the first type media file.

15. The digital processing system according to claim 11, wherein when the second type of media file is being played, the second user interface shows related information of the second type of media file.

16. The digital processing system according to claim 12, wherein the function includes a play function and an edit function.

17. The digital processing system according to claim 16, wherein the play function includes one of play, pause, stop, fast forward/rewind, automatic display, volume adjustment, setting a play order, and window's size adjustment.

18. The digital processing system according to claim 17, wherein the play order includes one of random play, sequence play, and loop play.

19. The digital processing system according to claim 16, wherein the edit function includes one of zooming, rotating, editing, resizing, and image processing.
